(19) United States
(12) Patent Application Publication
(10) Pub. No.: US 2009/0305938 A1
(43) Pub. Date: Dec. 10, 2009

(54) Production of Amine Oxide Granulates and the Use Thereof

(75) Inventors: Georg Assmann, Juechen (DE); Gerhard Blasey, Duesseldorf (DE); Hermann-Josef Welling, Monheim (DE); Birgit Burg, Duesseldorf (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/482,012

(22) Filed: Jun. 10, 2009

Related U.S. Application Data
(63) Continuation of application No. PCT/EP2007/062564, filed on Nov. 20, 2007.

(30) Foreign Application Priority Data
Dec. 13, 2006 (DE) 10 2006 059 272.7

(51) Int. Cl. C11D 3/30

(52) U.S. Cl. 510/356

(57) ABSTRACT

Surfactant granulates containing 10 to 90 wt. % amine oxide, 10 to 90 wt. % carrier material and 0 to 50 wt. % binder can be manufactured by fluidized bed granulation and employed for upgrading a washing detergent or cleaning agent composition. The upgraded washing detergent or cleaning agent composition is characterized inter alia by an improved performance for the removal of fat-containing stains.

### CROSS-REFERENCE TO RELATED APPLICATIONS

This application is a continuation under 35 U.S.C. §§ 120 and 365(c) of International Application PCT/EP2007/062564, filed on Nov. 20, 2007. This application also claims priority under 35 U.S.C. § 119 of DE 10 2006 059 272.7, filed on Dec. 13, 2006. The disclosures of PCT/EP2007/062564 and DE 10 2006 059 272.7 are incorporated herein by reference in their entirety.

### BACKGROUND OF THE INVENTION

The invention relates to surfactant granulates comprising 10 to 90% by weight of amine oxide, a process for manufacturing these granulates and the use of these granulates for increasing the performance of a surfactant-containing composition in regard to removing fat, a washing detergent or cleaning agent composition that comprises these granulates, as well as their use for improving the removal of fat from textiles.

Nowadays, washing detergents or cleaning agents are available to the consumer in a variety of commercial forms. In addition to powders and granulates, this range also includes, for example concentrates in the form of extruded or tableted compositions. These solid, concentrated or compressed commercial forms are characterized by a reduced volume per unit of dose and thereby lower packaging and transport costs, but have the disadvantage that because of the high compression of the material they are characterized by a slower release of their constituents. One possibility for accelerating the disintegration of compressed material is in the use of disintegration accelerators, so called tablet disintegrators.

Independently of whether the solid washing detergents or cleaning agents are present in the form of powders, granulates, extrudates or tablets, washing detergents or the strongest cleaning agents known up to now have weaknesses in regard to removing certain types of stains. Particularly when cleaning strongly soiled surfaces, for example strongly soiled work clothing, satisfactory results are not obtained when known washing detergents or cleaning agents are used. In order to improve the washing or cleaning results, the consumer has to use so called pre-treatment agents, with which the stains are rubbed or immersed prior to the actual washing or cleaning process, for example in an automatic washing machine, and in addition performance strengthening washing or cleaning agents are added to the actual washing detergent or cleaning agent. Even with what is such a laborious treatment for the consumer, it is often the case that fatty stains in particular cannot be completely successfully removed. As a result, the consumer has to stock up with the most varied pre-treatment agents and washing detergent and cleaning agent boosters, which have to be specifically dosed depending on the type and degree of stains for each washing or cleaning cycle. However, even then it is often the case that the stains are not completely successfully removed. The described problem is particularly frequent with clothing stained with mineral oil.

### DESCRIPTION OF THE INVENTION

The object of the present invention was to provide an additive for washing detergents or cleaning agents which solves the above-cited problems and thus enable the consumer to be given washing detergent or cleaning agent compositions that are distinguished by an improved cleaning power in particular in regard to fatty stains.

This object is achieved by the present invention.

The subject matter of the present invention is a surfactant granulate that comprises 10 to 90 wt. % amine oxide, 10 to 90 wt. % carrier material and 0 to 50 wt. % binder.

In the context of the present invention, the term, “granulate” includes in the narrow sense agglomerates, powder, coated particles, prills, etc.

The essential constituent of the inventive surfactant granulate is amine oxide that is comprised in the surfactant granulate in a quantity of 11 to 85 wt. %, preferably 12 to 80 wt. %, particularly preferably 13 to 75 wt. %, further preferably 14 to 70 wt. %, more preferably 15 to 65 wt. %, in preference to this 16 to 60 wt. %, quite particularly preferably 17 to 55 wt. % and especially 18 to 50 wt. %, wherein the data are based on the surfactant granulate.

The term, “amine oxide” is a collective noun for a group of non-ionic surfactants of the general Formula

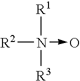

in which R usually stands for an aliphatic or even cyclic tertiary alkyl or amido alkyl group. Surface-active amine oxides are obtained by the oxidation of fatty amines or fatty amido amines with hydrogen peroxide.

In the context of the present invention, suitable surfactants of the amine oxide type have, for example the Formula R¹R²R³NO, in which each R¹, R² and R³ independently of each other is an optionally substituted C₁-C₃₀ hydrocarbon chain. Preferably, at least one of the groups, preferably at least two of the groups represent an optionally substituted C₁-C₆, preferably C₁-C₄ and especially C₁-C₃ hydrocarbon chain. The amine oxide particularly preferably has methyl groups and/or hydroxyethyl groups. The amine oxide is preferably selected from the group of the N—C₈₋₂₀ N,N-dialkylamine oxides, in particular from N-coco alkyl N,N-dialkylamine oxide, N-palm nut alkyl N,N-dialkylamine oxide, N-palm alkyl N,N-dialkylamine oxide and N-tallow alkyl N,N-dialkylamine oxide. Myristylcetyldimethylamine oxide or lauryidimethylamine oxide are likewise suitable.

The surfactant granulate can also comprise mixtures of two or more different amine oxides. In this case, the amine oxide content of the granulate is the result of the sum of the contents of all the comprised amine oxides.

The inventive surfactant granulate comprises the carrier material in an amount of 10 to 90 wt. %. Preferably the surfactant granulate comprises 15 to 85 wt. %, preferably 20 to 80 wt. %, more preferably 30 to 75 wt. %, particularly preferably 35 to 70 wt. % and especially up to 40 to 65 wt. % carrier material. Preferred carrier materials are carbonates, hydrogen carbonates, sesquicarbonates, sulfates, silicates, aluminosilicates, in particular zeolites, silicas, starch, cellulose derivatives, citric acid, citrates, tripolyphosphates and mixtures of these components. These substances will be described in detail in the text below.

The carrier material preferably has an oil absorption capacity of 10 ml/100 g to 160 ml/100 g, preferably 12.5 ml/100 g to 120 ml/100 g and especially 15 ml/100 g to 80 ml/100 g. The oil absorption capacity is a physical characteristic of a substance, which can be determined according to specified methods (ISO 787/5). In the test method, a weighed sample of the relevant substance is placed onto a plate and linseed oil (density: 0.93 g cm⁻³) is added drop wise from a burette. After each addition, the powder is intensively mixed with the oil using a spatula, the addition of the oil being continued until a paste having a smooth consistency is obtained. This paste should flow or run without crumbling. The oil absorption capacity is then the amount of the added oil, based on 100 g of absorbent, and is expressed in ml/100 g or g/100 g, wherein conversions with the density of the linseed oil are not a problem.

The surfactant granulate can optionally comprise binders in amounts of up to 50 wt. %. It has been determined that the free flowability of the inventive surfactant granulate can be improved if the granulate comprises at least 5 wt. %, preferably at least 10 wt. %, preferably at least 15 wt. % and especially at least 20 wt. % binder. Particularly suitable binders are solid substances at room temperature and 1 bar. The binder of the inventive surfactant granulate preferably comprises polymers and/or anionic surfactants.

Preferably employed polymers are copolymeric polycarboxylates, especially of (meth)acrylic acid and of maleic acid, for example those with a relative molecular weight of 500 to 70 000 g/mol.

The molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ significantly from the molecular weights measured against polystyrene sulfonic acids as the standard. The molecular weights measured against polystyrene sulfonic acids are generally significantly higher than the molecular weights mentioned in this specification.

Particularly suitable polymers are polyacrylates, which preferably have a molecular weight of 2000 to 20,000 g/mol. By virtue of their superior solubility, preferred representatives of this group are again the short-chain polyacrylates, which have molecular weights of 2000 to 10,000 g/mol and, more particularly, 3000 to 5000 g/mol.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2000 to 70,000 g/mol, preferably 20,000 to 50,000 g/mol and especially 30,000 to 40,000 g/mol.

Exemplary suitable anionic surfactants are those of the sulfonate and sulfate type. Suitable surfactants of the sulfonate type are, advantageously C₉₋₁₃ alkylbenzene sulfonates, olefin sulfonates, i.e. mixtures of alkene- and hydroxyalkane sulfonates and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g. the α-sulfonated methyl esters of hydrogenated coco-, palm nut- or tallow fatty acids are likewise suitable.

Further suitable anionic surfactants are sulfated fatty acid esters of glycerine. Fatty acid glycerine esters are understood to include the mono-, di- and triesters and also their mixtures, such as those obtained by the esterification of a monoglycerine with 1 to 3 moles fatty acid or by the transesterification of triglycerides with 0.3 to 2 moles glycerine. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali metal and especially the sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petrochemical basis and which show similar degradation behavior to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of washing performance. 2,3-Alkyl sulfates are also suitable anionic surfactants.

Sulfuric acid mono-esters derived from straight-chain or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates comprise C₈₋₁₈ fatty alcohol groups or mixtures of them. Especially preferred sulfosuccinates contain a fatty alcohol group derived from the ethoxylated fatty alcohols that are under consideration as non-ionic surfactants. Once again the particularly preferred sulfosuccinates are those, whose fatty alcohol groups are derived from ethoxylated fatty alcohols with narrow range homolog distribution. It is also possible to use alk(en)ylsuccinic acids with preferably 8 to 18 carbon atoms in the alk(en)yl chain, or salts thereof.

Soaps in particular can be considered as further anionic surfactants. Saturated fatty acid soaps are suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid.

Anionic surfactants, including the soaps, may be in the form of their sodium, potassium or ammonium salts or as soluble salts of organic bases, such as mono-, di- or triethanolamine. Preferably, the anionic surfactants are in the form of their sodium or potassium salts, especially in the form of the sodium salts.

Fatty alcohol sulfates, fatty alcohol ether sulfates, alkylbenzene sulfonates, alkane sulfonates, olefin sulfonates, methyl ester sulfonates and/or stearates are preferred as the anionic surfactants.

In preferred embodiments, the polymers and/or surfactants in the binder have a melting point of at least 25° C.

It has been determined that the inventive surfactant granulates have a particularly high solubility when the weight ratio of binder to amine oxide in the granulates is in the range 5:1 to 1:4, preferably 4:1 to 1:2 and especially 3:1 to 1:1. This is particularly true when anionic surfactant(s) is/are comprised as the binder.

A further improvement in the fat removal, even at low temperatures, has been found for inventive surfactant granules that additionally comprise polymeric graying inhibitors.

In the context of this invention, water-soluble colloids are suitable graying inhibitors, for example the water-soluble salts of polymeric carboxylic acids, glue, gelatines, salts of ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the abovementioned starch products, e.g. degraded starches, aldehyde starches etc. Polyvinyl pyrrolidone can also be used. Additional anti-graying inhibitors that can be used in the context of the present invention are cellulose ethers such as carboxymethyl cellulose (Na salt), methyl cellulose, hydroxyalkyl celluloses and mixed ethers such as methyl hydroxyethyl cellulose, methyl hydroxypropyl cellulose, methyl carboxymethyl cellulose and mixtures thereof. Particularly good results in regard to fat removal have been found by adding polymers of phthalic acid and/or terephthalic acid or their derivatives, especially polymers of ethylene terephthalates and/or polyethylene glycol terephthalates or anionically and/or non-ionically modified derivatives thereof. From these, the optionally sulfonated derivatives of the phthalic acid polymers and the terephthalic acid polymers are particularly preferred.

In a particularly preferred embodiment, the inventive surfactant granulate comprises up to 20 wt. %, preferably 2 to 15 wt. % and especially 4 to 10 wt. % polymeric graying inhibitors, in particular from the group of the (co)polymers based on polyethylene terephthalate.

Ingredients of washing detergents or cleaning agents, which can likewise be constituents of the inventive surfactant granulates, will be described later in the text. In order to avoid repetitions, descriptions of further optional ingredients of the inventive surfactant granulates, will not be made here. However, it is preferred that the inventive surfactant granulate comprises these further optional constituents in amounts of less than 50 wt. %, preferably less than 40 wt. %, particularly preferably less than 30 wt. %, more preferably less than 20 wt. % and especially less than 10 wt. %, based on the surfactant granulate.

According to a preferred embodiment of the invention, the Inventive surfactant granulate is regularly shaped, preferably in an almost spherical or elliptical shape. The mean shape factor of the granulates is preferably at least 0.79, preferably at least 0.81, more advantageously at least 0.83, more preferably than this at least 0.85 and especially at least 0.87.

In the meaning of the present invention, the shape factor or sphericity factor can be precisely determined by means of modern particle measurement techniques with digital image processing. A typical suitable particle shape analysis as can be carried out for example with the Camsizer® system from Retsch Technology or also with the KeSizer® from the Kemira Company, involves irradiating the particles with a light source and recording, digitalizing and calculating the particles as the projection surfaces by means of a computer. The surface curvature is determined by an optical measurement technique, whereby the shadow, cast by the investigated parts, is measured and used to calculate the corresponding shape factor. The measurement limits for this optical analytical method are 15 μm to 90 mm. Methods for measuring the shape factor of larger particles are known to the person skilled in the art. Generally, they are based on the principles of the abovementioned methods.

The particle size distribution of the inventive surfactant granulate is wherein at least 75 wt. %, preferably at least 85 wt. % and especially at least 95 wt. % of the particles have sizes between 200 and 2500 μm, preferably between 250 and 2000 μm and especially between 300 and 1600 μm. The mean particle size d₅₀ of the surfactant granulate is preferably between 200 and 1800 μm. Suitable methods for the determination of the particle size as well as the mean particle size of powders, granulates and agglomerates, abbreviated here as granulates, have long been known to the person skilled in the art. In the context of this invention, the particle sizes were determined by sieve analyses. The term, “mean particle size d₅₀” is understood to mean the value, for which 50% of the particles are smaller and 50% of the particles are larger (each based on the number of particles). Similarly, the term, “mean particle size d₉₀” is understood to mean the value, for which 90% of the particles are smaller and 10% of the particles are larger (each based on the number of particles). If, for example the inventive surfactant granulate is intended to be blended with a spray dried powder, then the mean particle size d₅₀ is preferably in the range 200 to 600 μm, preferably 250 to 550 μm and especially 300 to 500 μm. If, however the inventive surfactant granulate is intended to be mixed together with a coarsely grained base powder, then the mean particle size is preferably in the range 500 to 2000 μm, preferably 600 to 1900 μm, particularly preferably 700 to 1800 μm and especially 800 to 1700 μm.

A uniform particle size and consequently a narrow particle size distribution contributes to a positive overall impression of a granulate. A uniform particle size is when the particles have a size distribution, in which the ratio of d₅₀ to d₉₀ is at least 0.50, preferably at least 0.6, more preferably at least 0.75 and especially at least 0.80. The inventive surfactant granulate preferably has these characteristics.

It was surprisingly found that the inventive surfactant granulate has an improved, i.e. lower smell, in comparison with the added raw materials and the amine oxide-containing granulates of the prior art.

Furthermore, inventive surfactant granulates, even when they comprise poorly dispersible carrier materials, exhibit an improved solubility/dispersibility. In the context of the present invention, the residue value is determined by means of a standardized solubility test. The standardized solubility test will be described in the examples. For inventive surfactant granulates that comprise none or less than 10 wt. % anionic surfactant, the residue value is preferably less than 15 wt. %, preferably less than 10 wt. % and in particular less than 5 wt. %. It is known that gelation occurs with granulates that simultaneously contain anionic surfactants and especially alkylbenzene sulfonates and non-ionic surfactants, if these granulates are brought into contact with water. There results a low solubility/dispersibility of the corresponding granulate. It has surprisingly been found that inventive, anionic surfactant-containing surfactant granulates exhibit an improved solubility/dispersibility in comparison with granulates that contain anionic surfactants and non-ionic surfactants of the prior art; this can be quantified by a standardized solubility test. The residue value of the inventive anionic surfactant-containing surfactant granulates is preferably less than 70 wt. %, preferably less than 60 wt. %, more preferably less than 50 wt. % and especially less than 40 wt. %. Particularly preferred inventive anionic surfactant-containing surfactant granulates have a residue value significantly less than 30 wt. %.

As is generally known, the granulates of the prior art that comprise amine oxide have a markedly worse free flowability than granulates of a corresponding amine oxide-free formulation. Examples of granulates with an amine oxide content above 10 wt. % and which can still be considered as free flowing are practically unknown. In accordance with this, raw material suppliers advise that solids containing dried amine oxide are expected to be sticky. In comparison to the amine oxide-containing granulates from the prior art, the inventive granulates exhibit an improved free flowability. This is preferably max. 385%, more preferably max. 231% and especially between 100 and 192%. In the context of this invention, the free flowability is determined according to the flow test described in the examples.

The preferred subject matter of the present invention is a surfactant granulate comprising
20 to 50 wt. %, in particular 20 to 40 wt. % N—C₈₋₂₂ N,N-dialkylamine oxide, especially N—C₁₂₋₁₄ N,N-dialkylamine oxide,
30 to 65 wt. %, especially 35 to 65 wt. % carrier material, preferably silicon-containing carrier material and especially alumosilicate and/or silicate,
15 to 50 wt. %, especially 20 to 40 wt. % polymer and/or anionic surfactant which has/have a melting point of at least 25° C., especially polymeric polycarboxylate, alkylbenzene sulfonate and/or fatty alcohol sulfate and
0 to 20 wt. %, especially 2 to 15 wt. % anti-redeposition agent, especially anti-redeposition agents based on polyethylene terephthalate.

Another subject matter of the present invention is a washing detergent or cleaning agent composition comprising an inventive surfactant granulate and an additional surfactant-containing granulate that comprises at least 2 wt. % surfactant.

Any particulate material that appears suitable to the person skilled in the art can form the additional surfactant-containing granulate of the inventive washing detergent or cleaning agent composition. The additional surfactant-containing granulate preferably concerns a spray dried or granulated base powder that preferably comprises at least two components, one of which being imperatively surfactant. The additional surfactant-containing preferably includes builders that were agglomerated by adding agglomeration liquid in a high speed, medium speed or low speed mixer and then granulated. Spray dried material, materials manufactured by prilling or in a fluidized bed process, compositions granulated in high speed, medium speed or low speed mixers, extruded and/or roll compacted compositions or components can also be employed as the additional surfactant-containing granulate. The additional surfactant-containing granulate can be homogeneously constructed or can include one or more coating layers. In a preferred embodiment, the additional surfactant-containing granulate is a base powder of a washing detergent or cleaning agent or a granular additive, wherein the surfactant content of the additional surfactant-containing granulate is imperatively at least 2 wt. %.

If the inventive surfactant granulate is to be blended with a mixture of a plurality of granulates, then at least one of these granulates must comprise at least 2 wt. % surfactant, wherein the wt. % data of surfactant is based on said granulate and not the mixture of granulates to which the inventive surfactant granulate is blended.

The additional surfactant-containing granulate can comprise all washing detergent or cleaning agent constituents that appear suitable to the person skilled in the art. Suitable washing or cleaning active substances, preferably from the group of the builders, surfactants, polymers, bleaching agents, bleach activators, bleach catalysts, enzymes, disintegration aids, fragrances and perfume carriers, will be describe in more detail below. These components can also be comprised in the inventive surfactant granulate.

The builders include especially the zeolites, silicates, carbonates, organic co-builders and also—where there are no ecological reasons preventing their use-phosphates.

Of the suitable fine crystalline, synthetic zeolites containing bound water, zeolite A and/or P are preferred. Zeolite MAP® (commercial product of the Crosfield company), is particularly preferred as the zeolite P. However, zeolite X and mixtures of A, X and/or P are also suitable. Commercially available and preferably used in the context of the present invention is, for example, also a co-crystallizate of zeolite X and zeolite A (ca. 80 wt. % zeolite X), which can be described by the Formula

n Na₂O.(1−n) K₂O.Al₂O₃.(2−2.5)SiO₂.(3.5−5.5)H₂O

The zeolite can be added both as the builder in a granular compound as well as being used as a type of ‘dusting’ of a granular mixture, preferably a mixture to be compressed, wherein usually, both ways are used to incorporate the zeolite into the premix. Suitable zeolites have a mean particle size of less than 10 μm (volume distribution, as measured by the Coulter Counter Method) and comprise preferably 18 to 22% by weight and especially 20 to 22% by weight of bound water.

Crystalline layer-forming silicates of the general formula NaMSiₓO₂ₓ₊₁. y H₂O are preferably employed, wherein M represents sodium or hydrogen, x is a number from 1.9 to 22, preferably 1.9 to 4, wherein particularly preferred values for x are 2, 3 or 4 and y stands for a number from 0 to 33, preferably from 0 to 20. The crystalline layer-forming silicates of the formula NaMSiₓO₂ₓ₊₁. y H₂O are marketed for example by Clariant GmbH (Germany) under the trade name Na-SKS. Examples of these silicates are Na-SKS-1, (Na₂Si₂₂O₄₅.x H₂O, Kenyait), (Na-SKS-2, Na₂Si₁₄O₂₉.x H₂O, Magadiit), Na-SKS-3 (Na₂Si₈O₁₇.x H₂O) or Na-SKS-4 (Na₂Si₄O₉.xH₂O, Makatit).

Crystalline, layered silicates of formula NaMSiₓO₂ₓ₊₁, in which x stands for 2, are particularly suitable for the purposes of the present invention. Both β- and also δ-sodium disilicates Na₂Si₂O₅ y H₂O as well as additionally most notably Na-SKS-5 (α-Na₂Si₂O₅), Na-SKS-7 (β-Na₂Si₂O₅, Natrosilit), Na-SKS-9 (NaHSi₂O₅H₂O), Na-SKS-10 (NaHSi₂O₅ 3H₂O, Kanemit), Na-SKS-11 (t-Na₂Si₂O₅)and Na-SKS-13 (NaHSi₂O₅) are preferred but Na-SKS-6 (δ-Na₂Si₂O₅) is particularly preferred.

Other useful builders are amorphous sodium silicates with a modulus Na₂O: SiO₂ ratio of 1:2 to 1:3.3, preferably 1:2 to 1:2.8 and especially 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of the invention, the term “amorphous” is understood to encompass “X-ray amorphous”. In other words, the silicates do not produce any of the sharp X-ray reflexes typical of crystalline substances in X-ray diffraction experiments, but at best one or more maxima of the scattered X-radiation, which have a width of several degrees of the diffraction angle.

Alternatively or in combination with the above cited amorphous sodium silicates, X-ray amorphous silicates are employed, whose silicate particles yield blurred or even sharp diffraction maxima in electron diffraction experiments. This can be interpreted to mean that the products have microcrystalline regions between ten and a few hundred nm in size, values of up to at most 50 nm and especially up to at most 20 nm being preferred. These types of X-ray amorphous silicates similarly possess a delayed dissolution in comparison with the customary water glasses. Compacted/densified amorphous silicates, compounded amorphous silicates and over dried X-ray-amorphous silicates are particularly preferred.

Naturally, the generally known phosphates can also be added as builders, in so far that their use should not be avoided on ecological grounds. In the washing detergent and cleaning agent industry, among the many commercially available phosphates, the alkali metal phosphates are the most important and pentasodium or pentapotassium triphosphates (sodium or potassium tripolyphosphate) are particularly preferred.

“Alkali metal phosphates” is the collective term for the alkali metal (more particularly sodium and potassium) salts of the various phosphoric acids, in which metaphosphoric acids (HPO₃)ₙ and orthophosphoric acid (H₃PO₄) and representatives of higher molecular weight can be differentiated. The phosphates combine several inherent advantages: They act as alkalinity sources, prevent lime deposits on machine parts and lime incrustations in fabrics and, in addition, contribute towards the cleansing power.

The industrially important phosphates are the pentasodium triphosphate, Na₅P₃O₁₀ (sodium tripolyphosphate) as well as the corresponding potassium salt pentapotassium triphosphate K₅P₃O₁₀ (potassium tripolyphosphate). According to the invention, the sodium potassium tripolyphosphates are again preferably employed.

Further builders are the alkalinity sources. Alkali metal hydroxides, alkali metal carbonates, alkali metal hydrogen carbonates, alkali metal sesquicarbonates, the cited alkali silicates, alkali metal silicates and mixtures of the cited materials are examples of alkalinity sources that can be used, the alkali carbonates being preferably used, especially sodium carbonate, sodium hydrogen carbonate or sodium sesquicarbonate in the context of this invention. A builder system comprising a mixture of tripolyphosphate and sodium carbonate can be particularly preferred. Because of their low chemical compatibility—in comparison with other builders—with the usual ingredients of washing detergents and cleaning agents, the alkali metal hydroxides are preferably only incorporated in low amounts.

The addition of carbonate(s) and/or hydrogen carbonate(s), preferably alkali carbonate(s), particularly preferably sodium carbonate, is particularly preferred.

As organic co-builders, one may cite, in particular, polycarboxylates/poly-carboxylic acids, polymeric polycarboxylates, aspartic acid, polyacetals, dextrins as well as phosphonates. These classes of substances are described below.

Useful organic builders are, for example, the polycarboxylic acids that can be used in the form of the free acid and/or their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, amino carboxylic acids, nitrilotriacetic acid (NTA), providing such use is not ecologically unsafe, and mixtures thereof. Besides their building effect, the free acids also typically have the property of an acidifying component and hence also serve to establish a relatively low and mild pH of washing detergents and cleaning compositions. Citric acid, succinic acid, glutaric acid, adipic acid, gluconic acid and any mixtures thereof are particularly mentioned in this regard.

Other suitable builders are additional polymeric polycarboxylates, for example the alkali metal salts of polyacrylic or polymethacrylic acid, for example those with a relative molecular weight of 500 to 70 000 g/mol. Polymeric polycarboxylates have already been described as a suitable builder in the inventive surfactant granulates. These and other polymers can also be comprised in the additional surfactant-containing granulate.

In order to improve the water solubility, the polymers can also comprise allylsulfonic acids, such as for example, allyloxybenzene sulfonic acid and methallyl sulfonic acid as monomers.

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Other preferred copolymers are those, which preferably contain acrolein and acrylic acid/acrylic acid salts or acrolein and vinyl acetate as the monomers.

Similarly, other preferred builders are polymeric amino dicarboxylic acids, salts or precursors thereof. Polyaspartic acids or their salts are particularly preferred.

Further preferred builders are polyacetals that can be obtained by treating dialdehydes with polyol carboxylic acids that possess 5 to 7 carbon atoms and at least 3 hydroxyl groups. Preferred polyacetals are obtained from dialdehydes like glyoxal, glutaraldehyde, terephthalaldehyde as well as their mixtures and from polycarboxylic acids like gluconic acid and/or glucoheptonic acid.

Further suitable organic builders are dextrins, for example oligomers or polymers of carbohydrates that can be obtained by the partial hydrolysis of starches. The hydrolysis can be carried out using typical processes, for example acidic or enzymatic catalyzed processes. The hydrolysis products preferably have average molecular weights in the range 400 to 500,000 g/mol. A polysaccharide with a dextrose equivalent (DE) of 0.5 to 40 and, more particularly, 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2000 to 30,000 g/mol may be used.

The oxidized derivatives of such dextrins concern their reaction products with oxidizing agents that are capable of oxidizing at least one alcohol function of the saccharide ring to the carboxylic acid function.

Oxydisuccinates and other derivatives of disuccinates, preferably ethylenediamine disuccinate are also further suitable cobuilders. Ethylenediamine-N,N′-disuccinate (EDDS) is preferably used here in the form of its sodium or magnesium salts. In this context, glycerine disuccinates and glycerine trisuccinates are also preferred.

Other useful organic co-builders are, for example, acetylated hydroxycarboxylic acids and salts thereof, which optionally may also be present in lactone form and which contain at least 4 carbon atoms, at least one hydroxyl group and at most two acid groups.

In addition, any compounds capable of forming complexes with alkaline earth metal ions may be used as co-builders.

The additional surfactant-containing granulate must comprise at least 2 wt. % surfactant. In the inventive washing detergents or cleaning agents, the weight ratio of the amine oxide content of the inventive surfactant granulate to the surfactant content of the additional surfactant-containing granulate—independently of the added quantities of both these granulates in the final product—is preferably 0.1 to 45, particularly preferably 0.2 to 40, more preferably 0.3 to 35, preferably 0.4 to 30 and especially 0.5 to 25.

Based on the total formulation, the weight ratio between amine oxide that is a constituent of the inventive surfactant granulate to surfactant that is a constituent of the additional surfactant-containing granulate is preferably 0.001 to 50, preferably 0.01 to 25 and especially 0.1 to 5.

The additional surfactant-containing granulate particularly preferably comprises non-ionic surfactant. Once again, based on the total formulation, the weight ratio between amine oxide that is a constituent of the inventive surfactant granulate to non-ionic surfactant that is a constituent of the additional surfactant-containing granulate is preferably 0.001 to 10, preferably 0.0055 to 6 and especially 0.01 to 2.

All non-ionic surfactants known to the person skilled in the art can be used as the non-ionic surfactants in the additional surfactant-containing granulate. The preferred surfactants are weakly foaming non-ionic surfactants. Washing detergents or cleaning agents particularly preferably comprise non-ionic surfactants from the group of the alkoxylated alcohols. Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched groups in the form of the mixtures typically present in oxo alcohol groups. Particularly preferred are, however, alcohol ethoxylates with linear groups from alcohols of natural origin with 12 to 18 carbon atoms, e.g. from coco-, palm-, tallow- or oleyl alcohol, and an average of 2 to 8 EO per mol alcohol. Exemplary preferred ethoxylated alcohols include C₁₂₋₁₄ alcohols with 3 EO or 4EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, as well as mixtures of C₁₂₋₁₄ alcohol with 3 EO and C₁₂₋₁₈ alcohol with 5 EO. The cited degrees of ethoxylation constitute statistically average values that can be a whole or a fractional number for a specific product. Preferred alcohol ethoxylates have a narrowed homolog distribution (narrow range ethoxylates, NRE). Alternatively or in addition to these non-ionic surfactants, fatty alcohols with more than 12 EO can also be used. Examples of these are tallow fatty alcohol with 14 EO, 25 EO, 30 EO or 40 EO.

Furthermore, as additional non-ionic surfactants, alkyl glycosides that satisfy the general formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1.0 and 10, preferably between 1.2 and 1.4.

Another class of preferred non-ionic surfactants which may be used, either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain.

Non-ionic surfactants of the amine oxide type, for example N-coco alkyl N,N-dimethylamine oxide and N-tallow alkyl N,N-dihydroxyethylamine oxide, and the fatty acid alkanolamides can also be comprised in the additional surfactant-containing granulate. However, the additional surfactant-containing granulate preferably comprises less than 2 wt. %, preferably less than 1.5 wt. %, more preferably less than 1 wt. %, with preference less than 0.5 wt. % and especially no amine oxide.

Other suitable surfactants are polyhydroxyfatty acid amides corresponding to the formula:

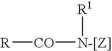

in which R stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the formula:

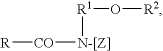

in which R is a linear or branched alkyl or alkenyl group containing 7 to 12 carbon atoms, R¹ is a linear, branched or cyclic alkyl group or an aryl radical containing 2 to 8 carbon atoms and R² is a linear, branched or cyclic alkyl group or an aryl group or an oxyalkyl group containing 1 to 8 carbon atoms, C₁₋₄-alkyl- or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

[Z] is preferably obtained by reductive amination of a reducing sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

Moreover, combinations of one or more tallow fat alcohols with 20 to 30 EO and silicone defoamers are particularly preferably used.

Non-ionic surfactants from the group of the alkoxylated alcohols, particularly preferably from the group of the mixed alkoxylated alcohols and especially from the group of the EO-AO-EO non-ionic surfactants, or of the PO/AO/PO non-ionic surfactants, especially the PO/EO/PO non-ionic surfactants are particularly preferred. Such PO/EO/PO non-ionic surfactants are characterized by good foam control.

Anionic surfactants can also be employed as a constituent of the additional surfactant-containing granulate. This class of substances has already been described as a suitable binder for the inventive surfactant granulate. Consequently, a repeat of the itemization is dispensed with here.

Cationic and/or amphoteric surfactants can be added instead of, or in combination with the cited surfactants.

As the cationic active substances, cationic compounds of the following formulae can be incorporated for example:

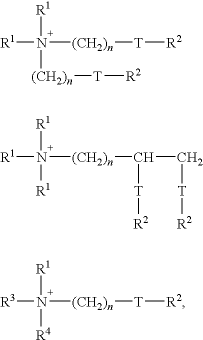

in which each group R¹, independently of one another, is selected from C₁₋₆ alkyl, -alkenyl or -hydroxyalkyl groups; each group R², independently of one another, is selected from C₈₋₂₈ alkyl or -alkenyl groups; R³═R¹ or (CH₂)ₙ-T-R²; R⁴═R¹ or R² or (CH₂)ₙ-T-R²; T=—CH₂—, —O—CO— or —CO—O— and n is an integer from 0 to 5.

Fabric softening compounds can be employed for fabric care and to improve the fabric properties such as a softer feel and lower electrostatic charging (increased wear comfort). The active principles of these formulations are quaternary ammonium compounds containing two hydrophobic groups, such as, for example, distearyldimethylammonium chloride that, however, due to its inadequate biodegradability is increasingly replaced by quaternary ammonium compounds that comprise ester groups in their hydrophobic groups as target break points for the biological degradation.

These types of “esterquats” with improved biodegradability can be obtained for example by the esterification of fatty acids with mixtures of methyldiethanolamine and/or triethanolamine and subsequent quaternization of the reaction products with alkylation agents by known methods. Dimethylol ethylene urea is also suitable as a finishing.

In preferred embodiments of the inventive washing detergent or cleaning agent composition, the additional surfactant-containing granulate contains at least 0.2 wt. %, preferably at least 0.4 wt. %, particularly preferably at least 0.6 wt. %, more preferably at least 0.8 wt. % and especially 1 wt. % of non-ionic surfactant, preferably alkoxylated non-ionic surfactant and especially ethoxylated fatty alcohol. In a preferred embodiment, the additional surfactant-containing granulate comprises max. 5 wt. %, preferably max. 4 wt. % and especially max. 3 wt. % of non-ionic surfactant. It can, however, be preferred that the additional surfactant-containing granulate has a high surfactant content, in particular a high content of non-ionic surfactant. In these preferred embodiments, the content of non-ionic surfactant in the additional surfactant-containing granulate ranges from 30 to 70 wt. %, preferably 35 to 65 wt. %, particularly preferably 40 to 60 wt. % and especially 45 to 55 wt. %. In this specific embodiment, the inventive washing detergent or cleaning agent contains two different highly concentrated non-ionic compounds, firstly the inventive surfactant granulate that contains 10 to 90 wt. % amine oxide, and secondly an additional surfactant-containing granulate that comprises 30 to 70 wt. % of non-ionic surfactant.

An inventive washing detergent or cleaning agent that includes, in addition to the inventive surfactant granulate, an additional surfactant-containing granulate that has at least 3 wt. % of alkoxylated, especially ethoxylated and/or propoxylated non-ionic surfactant with an alkoxylation degree of 3 to 10 and especially 3 to 8, is distinguished by a particularly good fat removal power. Very good performance in fat removability is obtained when the weight ratio of amine oxide comprised in the inventive surfactant granulate to the non-ionic surfactant comprised in all additional surfactant-containing granulates that are constituents of the inventive washing detergent or cleaning agent ranges from 0.01 to 5, preferably from 0.05 to 3 and especially from 0.1 to 2.

The additional surfactant-containing granulate preferably comprises anionic surfactant instead of or in addition to the non-ionic surfactant. An anionic surfactant content of 2 to 95 wt. %, preferably from 5 to 90 wt. %, more preferably from 8 to 85 wt. % and especially from 11 to 80 wt. % is particularly preferably appreciated.

In addition to the inventive surfactant granulate, the inventive washing detergent or cleaning agent preferably contains an additional surfactant-containing granulate that comprises 5 to 30 wt. %, preferably 7.5 to 27.5 wt. % and especially 10 to 25 wt. % anionic surfactant, particularly preferably at least in part alkylbenzene sulfonate, and/or an additional surfactant-containing granulate that contains 30 to 65 wt. %, preferably 35 to 55 wt. % and especially 40 to 50 wt. % anionic surfactant, particularly preferably at least in part alkylbenzene sulfonate, and/or an additional surfactant-containing granulate that contains 65 to 98 wt. %, preferably 72.5 to 95 wt. % and especially 80 to 92 wt. % anionic surfactant, particularly preferably at least in part fatty alcohol sulfate and/or methyl ester sulfonate.

The additional surfactant-containing granulate can further comprise polymers. The group of polymers includes, in particular the active washing detergent polymers or active cleaning polymers and/or polymers active for water softening. Generally, in addition to non-ionic polymers, also cationic, anionic or amphoteric polymers are suitable for incorporation in washing detergents or cleaning compositions.

In the context of the present invention, “cationic polymers” are polymers that carry a positive charge in the polymer molecule. These can be realized, for example, by (alkyl)ammonium groups present in the polymer chain or by other positively charged groups. Particularly preferred cationic polymers come from the groups of the quaternized cellulose derivatives, the polysiloxanes having quaternized groups, the cationic guar derivatives, the polymeric dimethyldiallylammonium salts and their copolymers with esters and amides of acrylic acid and methacrylic acid, the copolymers of vinyl pyrrolidone with quaternized derivatives of dialkylamino acrylate and dialkylamino methacrylate, the vinyl pyrrolidone/methoimidazolinium chloride copolymers, the quaternized polyvinyl alcohols or the polymers listed under the INCI descriptions Polyquaternium 2, Polyquaternium 17, Polyquaternium 18 and Polyquaternium 27.

In the context of the present invention, “amphoteric polymers” are polymers that also possess, in addition to a positively charged group in the polymer chain, further negatively charged groups or monomer units.

These groups can concern, for example, carboxylic acids, sulfonic acids or phosphonic acids.

The bleaching agents are a particularly preferably added active washing detergent or cleaning substance. Among the compounds, which serve as bleaches and liberate H₂O₂ in water, sodium percarbonate, sodium perborate tetrahydrate and sodium perborate monohydrate are of particular importance. Examples of further bleaching agents that may be used are peroxypyrophosphates, citrate perhydrates and H₂O₂-liberating peracidic salts or peracids, such as perbenzoates, peroxyphthalates, diperoxyazelaic acids, phthaloimino peracids or diperoxydodecanedioic acids.

Moreover, bleaching agents from the group of the organic bleaching agents can also be used. Typical organic bleaching agents are the diacyl peroxides, such as e.g. dibenzoyl peroxide. Further typical organic bleaching agents are the peroxy acids, wherein the alkylperoxy acids and the arylperoxy acids may be named as examples.

Chlorine- or bromine-releasing substances can also be incorporated as bleaching agents. Suitable chlorine- or bromine-releasing materials include, for example, heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

The washing detergents or cleaning agents can comprise bleach activators in order to achieve an improved bleaching action on washing or cleaning at temperatures of 60° C. and below. Bleach activators, which can be used, are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran, N-methyl-morpholinium acetonitrile-ethyl sulfate (MMA) as well as acetylated sorbitol and mannitol or their mixtures (SORMAN), acylated sugar derivatives, in particular pentaacetyl glucose (PAG), pentaacetyl fructose, tetraacetyl xylose and octaacetyl lactose as well as acetylated, optionally N-alkylated glucamine and gluconolactone, and/or N-acylated lactams, for example N-benzoyl caprolactam. Hydrophilically substituted acyl acetals and acyl lactams are also preferably used. Combinations of conventional bleach activators may also be used.

Enzymes can be incorporated to increase the washing or cleaning performance of washing detergents or cleaning agents. These particularly include proteases, amylases, lipases, hemicellulases, cellulases or oxidoreductases as well as preferably their mixtures. In principle, these enzymes are of natural origin; improved variants based on the natural molecules are available for use in detergents and accordingly they are preferred. The detergents or cleaning compositions preferably comprise enzymes in total quantities of 1×10⁻⁶ to 5 weight percent based on active protein. The protein concentration can be determined using known methods, for example the BCA Process or the biuret process.

Preferred proteases are those of the subtilisin type. Examples of these are subtilisins BPN′ and Carlsberg as well as the further developed forms, the protease PB92, the subtilisins 147 and 309, the alkaline protease from Bacillus lentus, subtilisin DY and those enzymes of the subtilases no longer however classified in the stricter sense as the subtilisines: thermitase, proteinase K and the proteases TW3 und TW7.

Examples of further useable amylases according to the invention are the α-amylases from Bacillus licheniformis, from B. amyloliquefaciens, from B. stearothermophilus, from Aspergillus niger and A. oryzae as well as their improved further developments for use in washing detergents and cleaning agents. Moreover, for these purposes, attention should be drawn to the α-amylase from Bacillus sp. A 7-7 (DSM 12368) and the cyclodextrin-glucanotransferase (CGTase) from B. agaradherens (DSM 9948).

According to the invention, lipases or cutinases can also be incorporated, particularly due to their triglyceride cleaving activities, but also in order to produce in situ peracids from suitable preliminary steps. These include for example the available or further developed lipases originating from Humicola lanuginosa (Thermomyces lanuginosus), particularly those with the amino acid substitution D96L. Moreover, suitable cutinases, for example are those that were originally isolated from Fusarium solani pisi and Humicola insolens. Further suitable are lipases or cutinases whose starting enzymes were originally isolated from Pseudomonas mendocina und Fusarium solanii.

In addition, enzymes, which are summarized under the term hemicellulases, can be added. These include, for example mannanases, xanthanlyases, pectinlyases (=pectinases), pectinesterases, pectatlyases, xyloglucanases (=xylanases), pullulanases und β-glucanases.

Perhydrolases are particularly preferably employed in the inventive agents.

To increase the bleaching action, oxidoreductases, for example oxidases, oxygenases, katalases, peroxidases, like halo-, chloro-, bromo-, lignin-, glucose- or manganese-peroxidases, dioxygenases or laccases (phenoloxidases, polyphenoloxidases) can be incorporated according to the invention. Advantageously, additional, preferably organic, particularly preferably aromatic compounds are added that interact with the enzymes to enhance the activity of the relative oxidoreductases or to facilitate the electron flow (mediators) between the oxidizing enzymes and the stains over strongly different redox potentials.

The enzymes can be added in each established form according to the prior art. Included here, for example, are solid preparations obtained by granulation, extrusion or lyophilization, or particularly for liquid compositions or compositions in the form of gels, enzyme solutions, advantageously highly concentrated, of low moisture content and/or mixed with stabilizers.

As an alternative application form, the enzymes can also be encapsulated, for example by spray drying or extrusion of the enzyme solution together with a preferably natural polymer or in the form of capsules, for example those in which the enzyme is embedded in a solidified gel, or in those of the core-shell type, in which an enzyme-containing core is covered with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluidized bed processes. Advantageously, these types of granulates, for example with an applied polymeric film former are dust-free and as a result of the coating are storage stable.

In addition, it is possible to formulate two or more enzymes together, so that a single granulate exhibits a plurality of enzymatic activities.

A protein and/or enzyme can be protected, particularly in storage, against deterioration such as, for example inactivation, denaturation or decomposition, for example through physical influences, oxidation or proteolytic cleavage. An inhibition of the proteolysis is particularly preferred during microbial preparation of proteins and/or enzymes, particularly when the compositions also contain proteases. For this use, washing detergents or cleaning agents can comprise stabilizers; the provision of these types of agents represents a preferred embodiment of the present invention.

In a preferred embodiment of the present invention, the inventive washing detergent or cleaning agent composition comprising the inventive surfactant granulate, an additional surfactant-containing granulate as well as optional additional solid or liquid components is compressed to a molded article.

In order to facilitate the disintegration of the preconditioned molded articles, disintegration aids, so-called tablet disintegrators, may be incorporated in these agents to shorten their disintegration times. Tablet disintegrators or disintegration accelerators are generally understood to mean auxiliaries that ensure a rapid disintegration of tablets in water or other media and the speedy release of the active substance.

These substances, which are also known as “disintegrators” by virtue of their effect, increase in volume on contact with water so that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

Disintegrants based on cellulose are the preferred disintegrants. Pure cellulose has the formal empirical composition (C₆H₁₀O₅)ₙ and, formally, is a β-1,4-polyacetal of cellobiose that, in turn, is made up of two molecules of glucose. Suitable celluloses consist of ca. 500 to 5000 glucose units and, accordingly, have average molecular weights of 50,000 to 500,000. In the context of the present invention, cellulose derivatives obtainable from cellulose by polymer-analogous reactions may also be used as cellulose-based disintegrators. These chemically modified celluloses include, for example, products of esterification or etherification reactions in which hydroxyl hydrogen atoms have been substituted. However, celluloses in which the hydroxyl groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and amino celluloses. The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. A particularly preferred cellulose-based disintegrator is pure cellulose, free from cellulose derivatives.

The cellulose, used as the disintegration aid, is advantageously not added in the form of fine particles, but rather conveyed in a coarser form prior to addition to the premix that will be compressed, for example granulated or compacted. The particle sizes of such disintegrators are mostly above 200 μm, advantageously with 90 wt. % between 300 and 1600 μm and particularly with at least 90 wt. % between 400 and 1200 μm.

Microcrystalline cellulose can be used as a further cellulose-based disintegration aid, or as an ingredient of this component. This microcrystalline cellulose is obtained by the partial hydrolysis of cellulose, under conditions, which only attack and fully dissolve the amorphous regions (ca. 30% of the total cellulosic mass) of the cellulose, leaving the crystalline regions (ca. 70%) intact. Subsequent disaggregation of the microfine cellulose, obtained by hydrolysis, yields microcrystalline celluloses with primary particle sizes of ca. 5 μm and for example, compactable granules with an average particle size of 200 μm.

Moreover, it can be preferred to incorporate additional effervescing systems as the tablet disintegration aids. The gas-evolving effervescent system can consist of a single substance, which liberates a gas on contact with water. Among these compounds, particular mention is made of magnesium peroxide, which liberates oxygen on contact with water. Normally, however, the gas-liberating effervescent system consists of at least two ingredients that react with one another to form gas. Although various possible systems could be used, for example systems releasing nitrogen, oxygen or hydrogen, the effervescent system used in the detergent and cleansing agent should be selected with both economic and ecological considerations in mind. Preferred effervescent systems consist of alkali metal carbonate and/or -hydrogen carbonate and an acidifying agent capable of releasing carbon dioxide from the alkali metal salts in aqueous solution.

In the context of the present invention, suitable perfume oils or fragrances include individual odoriferous compounds, for example synthetic products of the ester, ether, aldehyde, ketone, alcohol and hydrocarbon type. However, mixtures of various odoriferous substances, which together produce an attractive fragrant note, are preferably used. Perfume oils such as these may also contain natural odoriferous mixtures obtainable from vegetal sources, for example pine, citrus, jasmine, patchouli, rose or ylang-ylang oil.

The fragrances may be directly incorporated, although it can also be of advantage to apply the fragrances on carriers that due to a slower fragrance release ensure a long lasting fragrance. Suitable carrier materials are, for example, cyclodextrins, the cyclodextrin/perfume complexes optionally being coated with other auxiliaries.

The additional surfactant-containing granulate can comprise colorants. Care must be taken when selecting the dye, that the dye is storage stable and insensitive to light and does not have too strong an affinity towards textile surfaces and particularly here towards synthetic fibers. At the same time, the different stabilities of colorants towards oxidation must also be borne in mind when choosing suitable colorants. In general, water-insoluble colorants are more stable to oxidation than are water-soluble colorants. The concentration of the colorant in the washing detergents or cleaning compositions, is varied depending on the solubility and hence also on the propensity to oxidation. For colorants that are readily soluble in water, colorant concentrations in the range of 10⁻² to 10⁻³ wt. % are typically selected. For the less readily water-soluble, but due to their brilliance, particularly preferred pigment dyes, their suitable concentration in washing detergents or cleaning agent, in contrast, is typically several 10⁻³ to 10⁻⁴ wt. %.

In addition to the components described in detail above, the additional surfactant-containing granulate can comprise additional ingredients that further improve the application technological and/or esthetic properties of the inventive washing detergent or cleaning agent composition. Preferred additional surfactant-containing granulates comprise one or a plurality of materials from the group of the electrolytes, pH-adjustors, fluorescent agents, hydrotropes, foam inhibitors, silicone oils, anti-redeposition agents, optical brighteners, graying inhibitors, shrink inhibitors, anti-creasing agents, color transfer inhibitors, antimicrobials, germicides, fungicides, antioxidants, antistats, ironing auxiliaries, water proofing and impregnation agents, swelling and antipilling agents and UV absorbers.

A large number of the most varied salts from the group of the inorganic salts can be employed as the electrolytes. Preferred cations are the alkali metal and alkaline earth metals, preferred anions are the halides and sulfates. The addition of NaCl or MgCl₂ to the washing detergents or cleaning agents is preferred from the industrial manufacturing point of view.

The addition of pH adjustors can be considered for bringing the pH of the washing detergents or cleaning agents into the desired range. Any known acid or alkali can be added, in so far as their addition is not forbidden on technological or ecological grounds or grounds of protection of the consumer. The amount of these adjustors does not normally exceed 1 wt. % of the total formulation.

Graying inhibitors have the function of maintaining the dirt that was removed from the fibers suspended in the washing liquor, thereby preventing the dirt from resettling. Water-soluble colloids of mostly organic nature are suitable for this, for example the water-soluble salts of polymeric carboxylic acids, glue, gelatines, salts of ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the abovementioned starch products, e.g. degraded starches, aldehyde starches etc. Polyvinyl pyrrolidone can also be used. Additional anti-graying inhibitors that can be used are cellulose ethers such as carboxymethyl cellulose (Na salt), methyl cellulose, hydroxyalkyl celluloses and mixed ethers such as methyl hydroxyethyl cellulose, methyl hydroxypropyl cellulose, methyl carboxymethyl cellulose and mixtures thereof.

The preferred subject matter of the present invention is a washing detergent or cleaning agent that comprises at least the two granular components
an inventive surfactant granulate A that comprises 10 to 90 wt. % amine oxide, 10 to 90 wt. % carrier material, 0 to 50 wt. % and especially 15 to 50 wt. % binder having a melting point of at least 25° C., as well as 0 to 20 wt. % graying inhibitor that is preferably based on polyethylene terephthalate, and
an additional surfactant-containing granulate B that comprises at least 0.2 wt. % non-ionic surfactant that is preferably ethoxylated,
   and optionally contains additional granulates such as defoamer granulates, colored speckles, granular bleach preparations and/or enzyme preparations, wherein the weight ratio of the amine oxide comprised in the surfactant granulate A to the non-ionic surfactant in the additional surfactant-containing granulate, based on the total formulation of the washing detergent or cleaning agent is in the range 0.001 to 10, preferably 0.0055 to 6 and especially 0.01 to 2.

The inventive washing detergent or cleaning agent composition can be made available in granular form to the consumer or can be processed into a tablet, for example a circular or hollow tablet that can possess a plurality of compressed and optionally uncompressed phases. It is also possible to fill the inventive washing detergent or cleaning agent into a portioned package, for example a pouch, whose external coating is preferably formed of at least partially transparent, water-soluble or water-dispersible film. The portioned package can have a plurality of chambers and can comprise, in addition to the washing detergent or cleaning agent formulation in granular or compressed form, additional granular, compressed, liquid and/or gelled components.

A further subject matter of the present invention is a process for manufacturing an inventive surfactant granulate, in which carrier material is fluidized in a mixer and the liquid components are deposited onto the fluidized carrier material.

The term “liquid components” is also understood to mean here those components that are solid at 25° C. and 1 bar, but are liquid under the process conditions, such as for example is the case on melting.

This process enables amine oxide-containing granulates with the claimed concentration of amine oxide to be manufactured and which have an adequate solubility and free flowability in regard to their use in washing detergents or cleaning agents.

The amine oxide in the form of an amine oxide preparation and optionally a liquid (under the processing conditions) binder preparation are added as the liquid components in this process. Additional liquid components can also be added, but is not preferred.

In the context of the present description, the term, “amine oxide preparation” includes free flowable and/or sprayable, aqueous or non-aqueous preparations that comprise substantial quantities (min. 5 wt. %) of amine oxide. An aqueous amine oxide preparation with an actives content (amine oxide content) of 10 to 50 wt. % and especially 20 to 40 wt. % is preferably used in the inventive process. The amine oxide preparations used in the inventive process preferably comprise less than 5 wt. % of additional components, apart from the solvent, preferably water, and the amine oxide.

In the context of the present invention, the term, “binder preparation” includes individual solid or liquid binders and mixtures that comprise exclusively solid binders, exclusively liquid binders or solid and liquid binders, optionally mixed with one or more solvents. In the context of this paragraph, the properties, “solid” and “liquid” refer to the state of each of the binders at 25° C. and 1 bar. Binder preparations that comprise one or more solid binders and a solvent (mixture), especially water, are preferably employed in the inventive process.

In a preferred embodiment of the process, an amine oxide preparation and a binder preparation are separately metered into the mixer. However, it can be preferred on various grounds to meter in a previously manufactured mixture of amine oxide and binder into the mixer.

The amine oxide preparation respectively the mixture of amine oxide and binder preferably comprises 20 to 90 wt. %, preferably 40 to 85 wt. % and especially 60 to 80 wt. % water.

Particularly stable inventive surfactant granulates that have good solubility and good free flowability are obtained when the liquids are added in as neutral a form as possible. For this the liquid components are preferably adjusted to a neutral pH with citric acid. The amine oxide preparation as well as the optionally added binder preparation or the mixture of amine oxide and binder in the mixer preferably has a pH of 5 to 9, preferably 6 to 8 and especially 6.5 to 7.5.

The amine oxide preparation, the binder preparation and the mixture of amine oxide and binder are preferably sprayed by means of a nozzle onto the moving carrier material. The spraying can be made using single material high pressure spraying nozzles, spraying nozzles for two materials or spraying nozzles for three materials. For spraying with a single material spraying nozzle, the use of a high material pressure is required, whereas spraying in spraying nozzles for two materials is carried out by means of compressed air. Spraying with spray nozzles for two materials is more favorable, particularly in regard to potential blockages, but is more expensive due to the high consumption of compressed air. The spray nozzles for three materials, a modern development, have, besides the compressed air flow, an additional air delivery system for nebulization, which is intended to prevent blockages and droplet formation at the nozzle. In the context of the inventive process, the use of spray nozzles for two materials is particularly preferred. The liquid components are preferably sprayed as uniformly as possible onto the carrier material.

Any low, medium and high shear mixer known to the person skilled in the art can be used in the inventive process. Suitable mixers are free-fall mixers, thrust and turbulent mixers, gravity mixers and pneumatic mixers. Preferred free-fall mixers are drum mixers, tumble mixers, cone mixers, double cone mixers and V-blenders. Thrust mixers are mixers with moving mixing tools, in which the mixing tools move with a low speed. Exemplary suitable mixers are screw mixers and helical ribbon blenders. High speed mixers with moving mixing tools are designated as turbulent mixers and include for example paddle, plowshare, flat-bladed mixers and ribbon blenders. Mixers with a moving vessel and moving mixing tools which are employed are preferably plate mixers and counter flow intensive mixers. Suitable gravity mixers include mixing silos, bunkers or also belts. As suitable pneumatic mixers, once again mixing silos, fluidized bed mixers and jet mixers are considered.

The inventive process is particularly preferably carried out in a pneumatic fluidized bed.

For carrying out the process in the fluidized bed, it has proven advantageous to control the temperatures of the supply air, the fluidized bed as well as the liquid components that are sprayed on. Consequently, in the context of the present invention, preferred inventive processes are those in which the temperature of the supply air is between 30 and 220° C., preferably between 60 and 210° C. and especially between 90 and 200° C. and/or the temperature of the fluidized bed during the spraying of the liquid components is above 30° C., preferably above 45° C. and especially above 60° C. and/or the temperature of the sprayed on liquid components is above 30° C., preferably above 40° C. and especially above 50° C. If the liquid components are heated prior to spraying, then a higher throughput can be achieved in the inventive process.

There are also advantages associated with not heating the liquid components prior to spraying and to simply employ them above 0° C. but at max. room temperature, preferably above 10° C. and especially above 20° C., as in this way the equipment expense can be reduced because this embodiment does not require heat exchangers.

For manufacturing a washing detergent or cleaning agent composition, the surfactant granulates manufactured by means of the inventive process are blended in a subsequent process step with additional washing detergent or cleaning agent components, of which at least one comprises at least 2 wt. % of surfactant.

The use of an inventive surfactant granulate for improving the power of a surfactant-containing composition in regard to fat removability as well as the use of an inventive washing detergent or cleaning agent composition for an improved removal of fatty stains from textiles are additional subject matters of the present invention.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

The following Examples further illustrate the preferred embodiments within the scope of the present invention, but are not intended to be limiting thereof. It is understood that the examples and embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

### EXAMPLES

### Examples 1 and 2

From a 30 wt. % conc. amine oxide solution and a polymer solution was manufactured a homogeneous mixture of amine oxide and binder, in which mixture the amine oxide and the polymer were present in the weight ratio 1:1.

In a flat fluidized bed unit GPCG 5 were placed a zeolite compound (2.3 kg) and zeolite A (2.3 kg) and fluidized. The mixture of amine oxide and polymer was sprayed through a two-component spray nozzle onto the fluidized solids.

The temperature of the supply air for the fluidized bed drying was set to ca. 95° C. The temperature of the discharge air was 70° C.

The resulting granulates comprised 25 wt. % amine oxide, 25 wt. % polymer and 50 wt. % zeolite (including minor components of the zeolite compounds).

| | Example 1 | Example 2 |
|---|---|---|
| Polymer solution concentration | 20 wt. % | 30 wt. % |
| (binder preparation) | | |
| Amine oxide/binder mixture | 24 wt. % | 30 wt. % |
| concentration | | |
| Quantity of sprayed amine | 19.2 kg | 15.3 kg |
| oxide/binder mixture | | |
| Spray time | 110 | 100 minutes |
| | minutes | |
| Bulk density of the granulate | 488 g/l | 571 g/l |
| Solubility test (30° C., 90 s), residue | 1 wt. % | 5 wt. % |
| Clumping test | 0 g | 0 g |

Amine oxides: Genaminox ® LA ex Clariant (C_{12/14} alkyldimethylamine oxide in aqueous solution)
Polymer: Sokalan ® CP5 ex BASF (maleic acid-acrylic acid copolymer in aqueous solution) Zeolite compound: spray dried compound containing 77.2 wt. % zeolite A, 16.2 wt. % water, 2.0 wt. % CMC, 1.7 wt. % sodium sulfate, 1.7 wt. % non-ionic surfactant, previously available as Wessalith ® ex Degussa.

### Examples 3 and 4

An aqueous anionic surfactant paste was diluted with water to a concentration of 30 wt. % and the pH was adjusted with aqueous citric acid to 7.0. From the binder preparation and a 30 wt. % conc. amine oxide solution was manufactured a homogeneous mixture of amine oxide and binder, in which mixture the amine oxide and the polymer were present in the weight ratio 1:1. The mixture of amine oxide and polymer was sprayed through a two-component spray nozzle in a flat fluidized bed unit GPCG 5 onto 4.0 kg fluidized zeolite A.

The temperature of the supply air for the fluidized bed drying was set to ca. 95° C. The temperature of the discharge air was 70-72° C.

Zeolite A (0.3 kg) was added to the fluidized bed after 70 and 90 minutes. The resulting granulates comprised 25 wt. % amine oxide, 25 wt. % anionic surfactant and 50 wt. % zeolite.

| | Example 3 | Example 3 |
|---|---|---|
| Anionic surfactant | LAS-paste 55 wt. % | LAS-paste 65 wt. % |
| paste | conc., pH: 8.5-10 | conc., pH: 9.5-10.5 |
| Amine oxide/binder | 30 wt. % | 30 wt. % |
| mixture | | |
| concentration | | |
| Quantity of sprayed | 15.3 kg | 15.3 kg |
| amine oxide/binder | | |
| mixture | | |
| Spray time | 100 minutes | 110 minutes |
| Bulk density of the | 560 g/l | 570 g/l |
| granulate | | |
| Clumping test | 0 g | 0 g |

Amine oxide: Genaminox ® LA ex Clariant (C_{12/14} alkyldimethylamine oxide in aqueous solution)
LAS-paste: Maranil ® A 55 ex Cognis (sodium dodecylbenzene sulfonate as aqueous preparation)
FAS-paste: Sulfopon ® 1218 W ex Cognis (sodium-C₁₂₋₁₈ fatty alcohol sulfate as aqueous preparation)

Solubility Test

The solubility or dispersibility was determined by adding 0.05 g of the sample to be measured to 1000 ml mains water (16 d, 30° C.) with vigorous stirring in a beaker equipped with a propeller stirrer. After 90 seconds the solution was poured through a sieve (mesh size 0.2 mm), the equipment was rinsed out with a little water, this water also being poured through the sieve. After drying the sieve at 40° C. to constant weight, the sieve was weighed in the loaded and empty state, and the residue determined in %.

Flow Test

The flow behavior was determined by filling a powder funnel (the outlet of which being initially closed) with 1 liter of the sample to be measured; the emptying time of the sample was then measured and compared with the emptying time of dry sea sand. The emptying time of the dry sea sand after opening the outlet (13 seconds) was set to 100% and the times for the samples were reported in relation to this.

Clumping Test

The clumping behavior was determined by measuring out 15 ml of the sample into a 15 ml measuring cylinder and transferring the sample into a stainless steel cylinder that was standing in a glass petri dish. A stainless steel stamp having a diameter that exactly fits into the stainless steel cylinder was then inserted into the cylinder and then loaded with a weight of 415 g such that the sample was subjected to a total load of 500 g±1 g. Care was taken to ensure that the powder was not compressed by any other forces than the weight of the stainless steel stamp (+weight).

After 30 minutes at 20° C. the weight was removed, the cylinder was lifted up, and the agent was pushed out by the stamp.

If, due to clumping, the particles formed a dimensionally stable compacted body then the glass dish with the compacted body was placed under a weighing scale of a beam balance. A glass beaker was placed on this weighing scale and tared. Water was then slowly poured into the glass beaker until the compacted body was broken up by the pressure from above. The required quantity of water was weighed and represents the result of the clumping test.

What is claimed:

1. A washing detergent or cleaning agent composition comprising a first surfactant granulate comprising 10% to 90% by weight of an amine oxide, 10% to 90% by weight of a carrier material, and 0% to 50% by weight of a binder, and a second surfactant granulate comprising at least 2% by weight of a surfactant.

2. The composition of claim 1, wherein the amine oxide comprises an N—C₈₋₂₀ N,N-dialkylamine oxide.

3. The composition of claim 2, wherein the amine oxide comprises one or more of N-coco alkyl N,N-dialkylamine oxide, N-palm nut alkyl N,N-dialkylamine oxide, N-palm alkyl N,N-dialkylamine oxide, or N-tallow alkyl N,N-dialkylamine oxide.

4. The composition of claim 1, wherein the carrier material comprises one or more carbonates, hydrogen carbonates, sesquicarbonates, sulfates, silicates, aluminosilicates, silicas, starch, cellulose derivatives, citric acid, citrates, or tripolyphosphates.

5. The composition of claim 1, wherein the binder comprises one or more polymers or anionic surfactants.

6. The composition of claim 5, wherein the polymer comprises one or more copolymeric polycarboxylates.

7. The composition of claim 6, wherein the copolymeric polycarboxylate comprises a copolymer of acrylic acid and maleic acid or methacrylic acid and maleic acid.

8. The composition of claim 6, wherein the anionic surfactant comprises one or more fatty alcohol sulfates, fatty alcohol ether sulfates, alkylbenzene sulfonates, alkane sulfonates, olefin sulfonates, methyl ester sulfonates, or stearates.

9. The composition of claim 5, wherein the polymers and/or surfactants comprising the binder have a melting point of at least 25° C.

10. The composition of claim 1, wherein the first surfactant granulate comprises up to 20% by weight of a polymeric anti-redeposition agent.

11. The composition of claim 10, wherein the polymeric anti-redeposition agent comprises one or more (co)polymers based on polyethylene terephthalate.

12. The composition of claim 1, wherein the second surfactant granulate comprises at least 0.2% by weight of one or more nonionic surfactants.

13. The composition of claim 12, wherein the one or more nonionic surfactants comprise one or more alkoxylated non-ionic surfactants.

14. The composition of claim 13, wherein the one or more alkoxylated nonionic surfactants comprise one or more ethoxylated fatty alcohols.

15. A process for manufacturing a surfactant granulate, comprising the steps of fluidizing a carrier material in a mixer and depositing one or more liquid components comprising an amine oxide and optionally a binder onto the fluidized carrier material, to form a surfactant granulate comprising 10% to 90% by weight of an amine oxide, 10% to 90% by weight of a carrier material, and 0% to 50% by weight of a binder.

16. The process of claim 15, wherein the amine oxide and the binder are separately metered into the mixer.

17. The process of claim 15, wherein the amine oxide and binder are combined before being metered into the mixer.

18. The process of claim 15, wherein the liquid component comprising an amine oxide comprises 20% to 90% by weight of water.

19. The process of claim 15, wherein the one or more liquid components comprising an amine oxide and optionally a binder have a pH of 5 to 9.

20. A process of removing a fat from a fat stain on a substrate, comprising contacting a fat stain on a substrate with an amount of the composition of claim 1 effective to remove said fat at least in part from the substrate.
